(19) United States
(12) Patent Application Publication
(10) Pub. No.: US 2010/0063426 A1
(43) Pub. Date: Mar. 11, 2010

(54) VIBRATION APPARATUS FOR USE ON THERAPY AND EXERCISE EQUIPMENT, AND A METHOD FOR PROVIDING CONTROLLABLE VIBRATION TO SUCH EQUIPMENT

(75) Inventor: Tore Planke, Borøy (NO)

Correspondence Address: VOLPE AND KOENIG, P.C., UNITED PLAZA, SUITE 1600, 30 SOUTH 17TH STREET, PHILADELPHIA, PA, 19103, US

(73) Assignee: REDCORD AS, Staubø (NO)

(21) Appl. No.: 12/522,059

(22) PCT Filed: Jan. 7, 2008
(86) PCT No.: PCT/NO2008/000003

§ 371 Date: Nov. 3, 2009

(30) Foreign Application Priority Data
Jan. 8, 2007 (NO) 20070115

(51) Int. Cl. A61H 1/00; A63B 21/00

(52) U.S. Cl. 601/46; 482/131

(57) ABSTRACT

A vibration apparatus for use on therapy and exercise equipment of the type that has one adjustable, hanging rope or a pair of adjustable, hanging ropes to which is attached a grip portion, sling or other support member for an equipment user, the vibration apparatus being designed to be attached to the rope or to extend between the ropes and controllably set the rope or ropes in vibration. The vibration apparatus is freely, but fixably mountable at any level along the hanging length of the rope or ropes by means of rope gripping members on the apparatus or at respective ends of the apparatus, and the vibration apparatus has an actuator, for example, in the form of at least one electrically controllable motor that cooperates with at least one weight that is eccentrically supported in relation to the rotational axis of the motor.

The present invention relates to a vibration apparatus for use on therapy and exercise equipment of the type having a pair of adjustable, hanging ropes to which is attached a grip portion, sling or other support member for an equipment user, the vibration apparatus being designed to extend between the ropes and controllably set the ropes in vibration. Further, the invention relates to a vibration apparatus for use on therapy and exercise equipment of the type having one adjustable, hanging rope to which is attached a grip portion, sling or other support member for an equipment user, wherein the vibration apparatus is designed to be attachable to the rope and controllably set the rope in vibration. Use of such equipment takes place under or after instruction in the form of expert guidance from a treatment or exercise therapist.

Related to the invention is also a method for providing controllable vibration to therapy and exercise equipment of the type that has one adjustable, hanging rope or a pair of adjustable, hanging ropes to which is attached a grip portion, sling or other support member.

Vibration apparatus of this type are described in the Applicant's earlier Norwegian Patent Application No. 20045182 and in corresponding International Patent Application PCT/NO2005/000438. These patent applications also describe the underlying theory for setting such hanging ropes in vibration.

As disclosed in these earlier applications, such therapy and exercise equipment is often referred to in connection with grip portions or so-called slings that are connected to ropes and which via guides in the ceiling or on a wall are length-adjustable and can be locked via a rope fastener on, e.g., a wall. However, the solution requires that the slings be left in order to adjust the rope lengths, or that another person assists with the adjustment. The Applicant, Redcord AS (formerly Nordisk Terapi AS), Norway, therefore developed many years ago an apparatus known as TrimMaster™ or TerapiMaster™, now marketed under the name Redcord Trainer™, and this apparatus was a considerable improvement on the previously known solutions, as it was no longer necessary for the equipment user to move away from the grip means or the slings in order to be able to adjust rope length, or to have an assistant for such adjustment. This apparatus is widely used for rehabilitation, physiotherapy treatment, strength training and mobility training of patients in hospitals and at physiotherapy institutes, or it used in fitness studios or fitness rooms in places of work or in private homes.

Prior to said patent applications, attention was beginning to be focused on why active, volitional muscle training did not always give the expected results. Well documented studies show that treatment of certain disorders, especially chronic musculoskeletal disorders, has a faster and more lasting effect if the joints are subjected to instability and vibrations during therapy and exercise.

In the said patent applications, it is stated that recent studies indicate that certain muscles have a quite special stabilising function, namely the “local” muscles that are close to the joints and have a majority of tonic muscle fibres (deeper-lying stabilising muscles). Such local muscles are believed to be responsible for joint stability in the extremities and segmental stability in the back and neck. The “global” muscles that have a majority of phasic muscle fibres are often referred to as superficial musculature and their main function is to carry out movements. This muscle group is strengthened through conventional strength training. On, for example, sudden movements of the upper body or the extremities, it is actually the local stabilising musculature that is activated first by what is termed a “feed forward mechanism”. It has also been documented that patients with chronic back pain have lost the feed forward mechanism of the deep-lying stabilising musculature in the abdomen and back. In connection with long-term problems such as back problems, it has been documented that the sensory motor function is reduced. Sensory motor function ensures both input into and output from the central nervous system (CNS). Training sensory motor function is therefore important.

It was thus a major discovery that an enhanced effect of the local stabilising musculature was obtained by subjecting the patient to a certain degree of instability. This can easily be done by allowing the patient, for example, to stand upright, kneel or sit on a “wobble cushion” with his hands gripping the slings of the exercise apparatus. Alternatively, the patient could be allowed to lie on his back with a “wobble cushion” under his buttocks and his legs in the slings of the exercise apparatus. The utilisability and characteristics of the exercise apparatus also make it easy for the patient to exercise at home between therapy sessions with a treatment or exercise therapist. This may be advantageous, if not essential, for ameliorating the patient's chronic musculoskeletal problems.

As pointed out in the Applicant's said earlier patent applications, the stabilising musculature is thus deeper lying musculature which has normal activity in healthy individuals. In chronic pain patients, this musculature has impaired activity through a reduced signal flow from the CNS. Local stabilising musculature ensures stability of joints and prevents abnormal joint displacements. Patients with chronic pain who subject their joints to substantial loads, where the said stabilising capability does not function, will experience that heavy lifts/increased loads lead to pain. The ability to restore activity of local stabilising musculature is therefore the key to better function and less pain for this patient group. Exercises that challenge stability and place increased demands on sensory motor control seem to revive and restore the capability the stabilising musculature is supposed to have. It is conceived that if the brain is stimulated to perceive an abnormality or state of danger in a stabilising musculature area, it will, without any control by the person in question, restore signals to this musculature. Experience has shown that unstable exercises in combination with vibrations will automatically lead to an increased signal flow to this local musculature surrounding the joints, restore local stabilisation, lead to better function and result in a considerable reduction or even loss of pain.

It is a known fact that walking in woods and forest areas in rough terrain is a much used form of strength training for the body musculature. The brain will in certain cases instinctively register dangers of instability and of turning an ankle if the local stabilising musculature in, e.g., the ankle joint, is not kept constantly active. The brain will also unconsciously receive danger signals for the back muscles when walking in rough terrain or terrain where there is a great risk of losing one's balance, and thus the stabilising musculature of the back will be unconsciously stimulated from the brain to “exercise” the stabilising musculature at the joints.

In the light of such practical experience, it has been concluded that joint pain, which often travels to other parts of the body, seems to be due to the fact that the local or “unconscious” stabilising musculature has lost its ability to work optimally because of reduced signal flow from the CNS, and this communication can in some circumstances be stimulated.

This conclusion led to what resulted in the invention that is described in aforementioned Norwegian Patent Application 20045182 and in the corresponding international application, PCT/NO2005/000438.

Tests carried out by the Applicant prior to said earlier patent applications and further tests which have been carried out after the filing date of these applications, where at least parts of the body are subjected to imbalance, e.g., by a person being supported by an unstable surface, even when the joint is loaded, optionally with volitional muscular movement in addition, has shown that even short-term therapy and exercise under such unstable conditions gives substantial alleviation and, in many cases, elimination of joint pain, whilst original functionality is restored.

Further conducted tests have shown that if instability is provided via an exercise apparatus as defined above, i.e., Redcord Trainer or as a supplement to other instability, substantial alleviation of joint pain associated with weak, “local” or “unconscious” stabilising musculature at one or more joints can be obtained.

Thus, the therapy scheme that is possible when using Sling Exercise Therapy (SET) could, with the Applicant's earlier invention, be made even more effective and thus reduce treatment time for the patient.

However, it has been found by further testing after the filing date of the Applicant's said earlier patent applications that the vibratory force required to obtain the desired therapy results does not necessarily need to be so great, whilst it may be desirable to adjust the vibration frequency wholly or partly independent of the vibratory force.

It has further been found to be expedient to be able to subject both ropes to vibration simultaneously, so that the vibrations are almost in phase with an adjustable vibration frequency, and to be able steplessly to attach the point of application for such vibrations along the ropes so as to also adjust the “lever arm” that is related to the vibration which affects the patient at the hand grip or the sling.

### SUMMARY

Therefore, the object of the present invention is to provide an apparatus of the type mentioned in the introduction, which makes it possible for the just mentioned goals to be achieved, whilst the apparatus is mechanically simple, functionally simple, easy to produce, easy to operate, safe to use and inexpensive to purchase and run.

An additional object of the invention is that the vibration apparatus can easily be used on existing exercise equipment that has hanging ropes with grip portions or slings for the user, and where the length of the ropes is adjustable, whilst such an apparatus should be simple to secure or position-adjust on the ropes, and to attach to and release from the ropes. The vibration apparatus is not limited to use on exercise equipment of the Redcord Trainer™ type, but can equally well be used on equipment where the fastening of ropes or the adjustment of the length of hanging ropes is effected by using a rope fastener on, e.g., a wall.

The vibration apparatus is characterised according to the invention in that the vibration apparatus is freely, but fixably mountable at any level along the hanging length of the ropes by means of rope gripping members at respective ends of the apparatus, and that the vibration apparatus has at least one electrically controllable actuator that cooperates with at least one movable weight.

The vibration device is characterised according to the invention in that the vibration apparatus is freely, but fixably mountable at any level along the hanging length of the rope by means of rope gripping members on the apparatus, and that the vibration apparatus has at least two electrically controllable actuators, each of which cooperates with at least one movable weight.

The aforementioned method is characterised according to the invention in that vibration is selectively applicable at a desired point along the hanging length of the rope or ropes by means of at least one electrically controllable actuator which comprises a movable weight.

The invention will now be described in more detail with reference to exemplary embodiments and the attached drawing figures.

### BRIEF DESCRIPTION OF THE DRAWINGS

FIG. 1 shows a known principle of kneeling forward falls/push-ups using a Redcord Trainer™ together with a “wobble cushion” to create instability, and together with the use of the vibration apparatus according to the invention.

FIG. 2 shows the same as FIG. 1 with the vibration apparatus according to the invention mounted in vibratory engagement with the rope of the exercise apparatus.

FIG. 3 shows a first embodiment of the apparatus according to the invention.

FIGS. 4 and 5 show alternative positions of eccentric weight-equipped motors.

FIGS. 6a and 6b show modified rope gripping members in relation to those shown in FIG. 3.

FIG. 7 shows in more detail an exemplary embodiment of an eccentric weight-equipped motor.

FIG. 8 shows in the form of a block diagram the electric/electronic elements included in the apparatus.

FIG. 9 shows a second use, in relation to FIG. 1, of the vibration apparatus according to the invention.

FIG. 10 shows an alternative, simplified embodiment of the vibration apparatus according to the invention.

FIGS. 11a and 11b, 12a and 12b, 13a and 13b, 14, 15 and 16 show as non-limiting examples alternative actuators for the generation of vibration.

FIG. 17 shows how access to the adjustable actuator or actuators in the vibration apparatus can be facilitated.

### DETAILED DESCRIPTION OF THE PREFERRED EMBODIMENTS

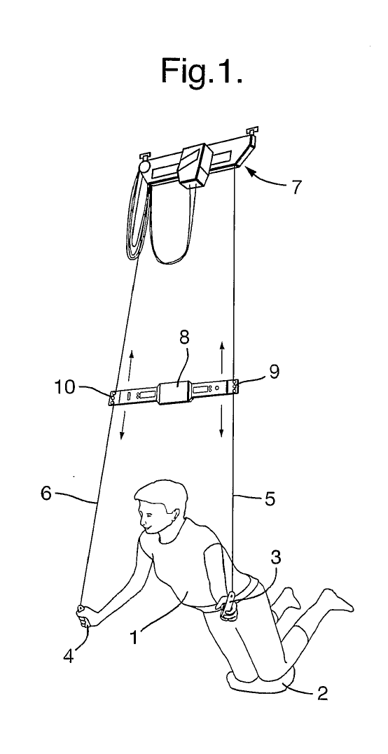

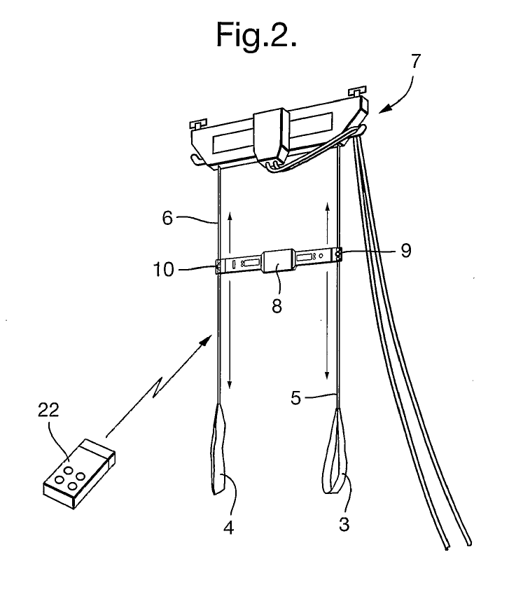

In the purely exemplary solution shown in FIGS. 1 and 2, the user 1 employs a so-called “wobble cushion” 2 in cooperation with slings or grip portions 3, 4 and where hanging ropes 5, 6, e.g., from Redcord Trainer™ 7 are included. An instability situation is thus created which will help to stimulate sensory motor control, i.e., that the central nervous system (CNS) receives a message of a clear instability situation in the local muscles at the joints. The CNS gives an increased signal flow back to the muscles that will increase their tensioning and stabilising function, which in turn will help to reduce joint pain and related pain. Securing and operating a vibration apparatus 8 on the pair of hanging ropes 5, 6 will result in the deep-lying stabilising musculature being further stimulated, so that the therapy is as optimal as possible. Attachment of the vibration apparatus 8 to the ropes 5, 6 is effected by means of rope gripping members 9, 10 at each end of the vibration device 8.

The point of attachment of the vibration apparatus 8 on the ropes, i.e., the distance along the ropes 5, 6 from the rope gripping members 9, 10 of the vibration apparatus to the slings or grip portions 3, 4 will also be partly determining for the vibration amplitudes that will act at on the slings or grip portions 3, 4, i.e., the character of vibration in addition to the vibration frequency or frequencies that a patient/the user 1 of the equipment will feel during therapy/exercise.

It will be understood that on using, for example, Redcord Trainer™ 7, the length of the ropes, i.e., the level of the slings or grip portions 3; 4 above, e.g., a floor will be adjustable. If another type of exercise equipment is used, e.g., where the length of the ropes is adjustable by being run over pulleys and secured to fasteners on a wall, the apparatus according to the invention will also be capable of being used on such equipment.

As indicated in FIG. 2, the vibration apparatus 8 is freely, but fixably mountable at any level along the hanging part of the ropes 5, 6 by means of rope gripping members 9, 10. The vibration apparatus 8 has, in the currently preferred embodiment, at least one electrically controllable motor 11; 12; 13 which cooperates with at least one eccentrically supported weight 11′; 11″; 12′; 12″; 13′; 13″.

The vibratory force is dependent on two factors: the rotational speed of the motor and the weight of the weight and/or its distance from the rotational axis of the motor shaft. To obtain a broad spectrum of vibratory effects, it will therefore be expedient to have several motors having different eccentrically supported weights. Li the illustrated example, three motors 11-13 equipped with eccentrically supported weights 11′-13″ are used. Although the apparatus can basically function well with one motor and associated eccentrically supported weight, a preferred embodiment will have at least two motors with associated different or optionally identical eccentrically supported weights. By different weights may be understood, for example, that they have a different shape and/or weight and/or distance from the rotational axis of the motor shaft.

This means that when, for example, the motor 11 rotates at a certain frequency (i.e., revolutions per minute (RVM), the vibratory force has a certain value. If, instead, the motor 12 or 13 rotates at the same frequency, the respective rotational force will have a different value if the weights are different in size, shape and/or distance from the axis of rotation. It is conceivable that the weights may have the same shape and/or weight, but that the distance from the rotational axis of the motor shaft is different.

As shown in FIG. 7, said weight 11′; 11″; 12′, 12″; 13′; 13″ will be eccentrically mounted on the rotary shaft of the motor 11; 12; 13. Although the motors are shown with two eccentrically mounted weights mounted thereon, it is of course conceivable to use only one eccentric weight on one or more of the motors. This will depend upon the shape and weight of the eccentric weights.

Advantageously, the vibration apparatus has a vibration frequency in the range 10-120 Hz, but applications outside this range are also possible, for example, in the range 1-10 Hz and/or optionally above 120 Hz. When using, for example, several motors with associated weights, a composite frequency pattern could be obtained with frequencies taken within the outlined range of 10-120 Hz, but optionally also containing frequencies taken outside this range, as indicated.

To obtain sufficient therapeutic effect, it is not necessary that the vibration amplitudes are large, but in most cases they should merely be such that they can be felt by the user. The user 1, when subjected to such vibrations, will gradually be able to raise his tolerance level therefor, i.e., with regard to vibration amplitude and vibration frequency. Repeated therapy sessions will be desirable in order to obtain long-term effect of the therapy. The duration of the therapy can, depending on the user concerned, for example, last from about 30 seconds to several minutes, preferably with a progressive increase during the therapy period from the previous therapy session to the next therapy session.

The vibration frequency and the vibratory force will be single-valued as long as only one motor is in operation at a time. When, however, two or more motors operate simultaneously, they must rotate synchronously to ensure that vibration frequency and vibratory force are single-valued. Initially, this will call for slightly more sophisticated motor control than if each motor could operate freely in relation to at least one additional motor.

On individual operation of the motors (non-synchronised) and when at least two of them operate simultaneously, there will be obtained a composite vibration frequency pattern, and a vibration frequency which is not necessarily rhythmic as is the case when one motor is in operation, but may be experienced as arrhythmic. It has been found that treating a patient using such a composite frequency pattern and a slightly arrhythmic vibratory force provides better or good therapy for certain joint diseases.

The vibration apparatus has equipment for adjusting at least one of the following parameters: motor rotational speed 14, duration of rotation 15, and selection 16 of the motor or motors 11; 12; 13 that are to rotate together with associated eccentrically supported weight 11′; 11″; 12′; 12″; 13′; 13″. There will in addition be a vibration frequency indicator 14′ and a vibration duration indicator 15′. In addition, there is an ON/OFF button 17 and external power supply 18. It is of course also conceivable that the vibration apparatus is battery-operated.

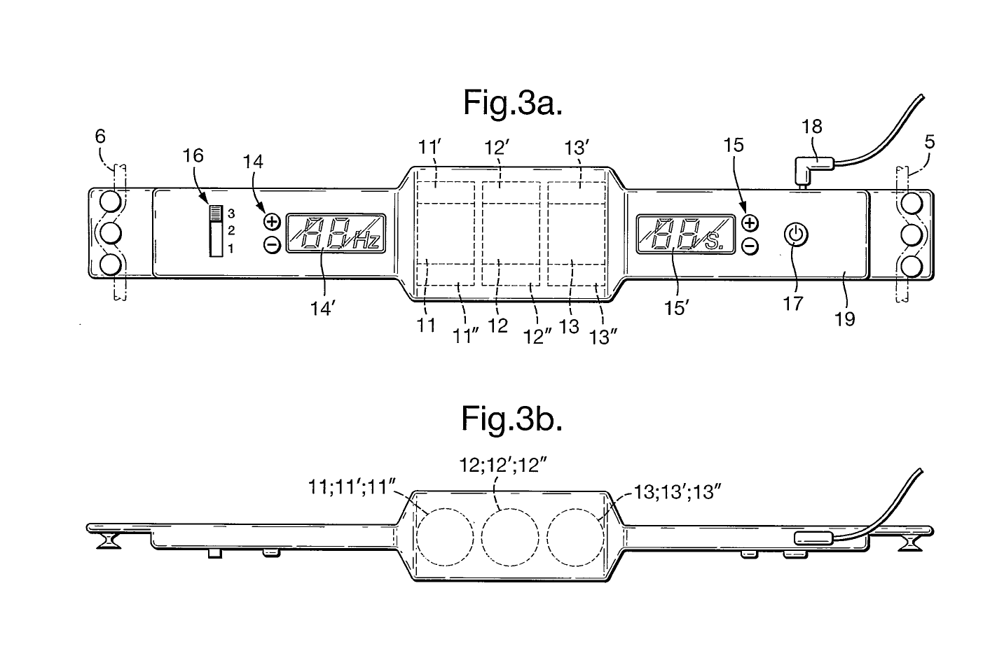

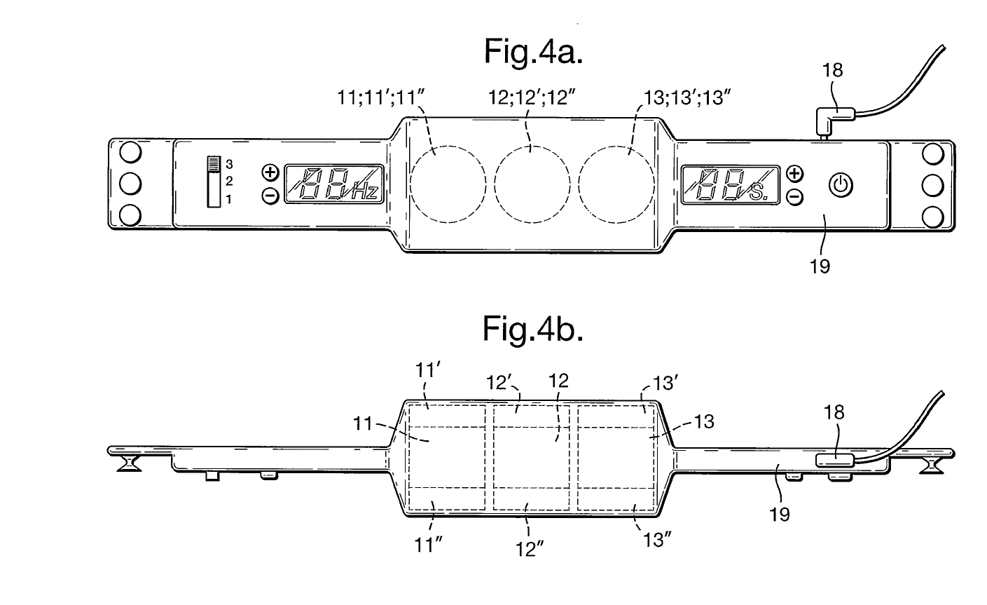

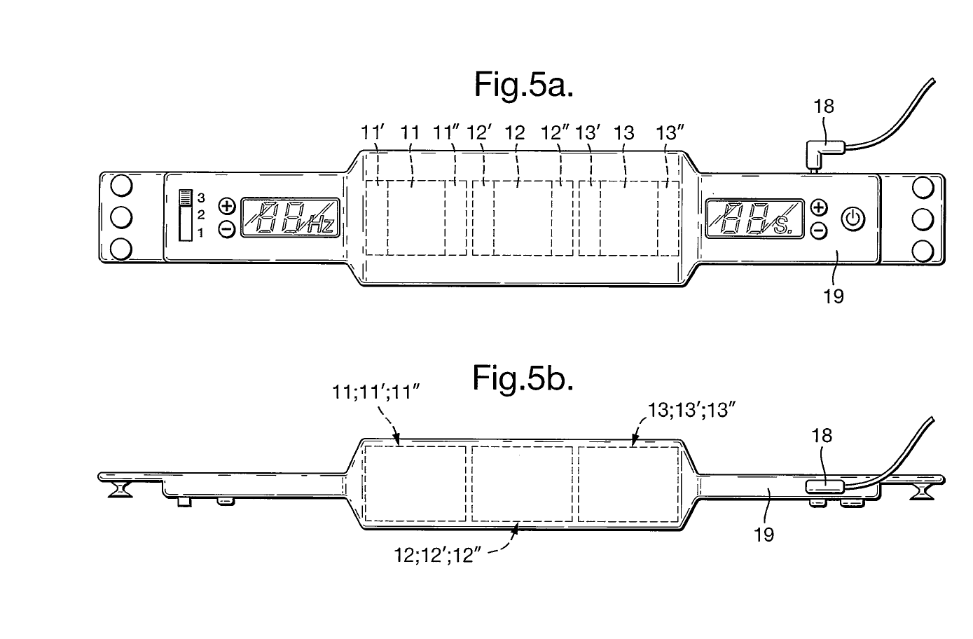

The vibration apparatus is, in the currently preferred and commercialised form, configured with an elongate, rigid housing 19, as shown in FIGS. 3a and 3b, and in FIGS. 4a, 4b, 5a and 5b, and where said at least one motor 11; 12; 13 with associated eccentrically supported weights 11′; 11″; 12′; 12″; 13′; 13″ is located internally in a central region of the housing 19.

On simultaneous operation of, for example, two or more motors and their eccentric weights, it is conceivable to be able to program the vibration apparatus so that it is given special operational modes with regard to composite vibration frequency pattern and associated vibratory forces. For this use, a central processing unit 20 can be used in the vibration apparatus which, via a separate display 21 or by using the display 14′, shows the vibration program in question. The processing unit is expediently arranged for optional remote control from a remote control unit 22 (see FIG. 2) via a receiver 23, 23′ on the processing unit. The control signals may be of all known types such as: radio waves, ultrasound, optical etc. In addition, there may be a possibility for external connection to the processor 20 via a data port 24, such as, for example, a data port of the USB type. This port will permit easy programming and updating of software in the processing unit, and advanced management, control and retrieval of data concerning an implemented therapy/exercise program for a patient.

As shown in FIGS. 3a and 3b, the rotary shaft of each motor, when the vibration apparatus is attached to the pair of ropes 5, 6, has its axis of rotation parallel to the inclination of the ropes close to their connection to the apparatus.

In the alternative solution shown in FIGS. 4a and 4b, the rotary shaft of respective motors 11; 12; 13, when the vibration apparatus 8 is attached to the pair of ropes 5, 6, has its axis of rotation transverse to the housing 19 and thus about 90° in relation to the inclination of the ropes close to their connection to the apparatus.

According to the additional alternative solution shown in FIGS. 5a and 5b, the rotational axis of the rotary shaft of each motor 11; 12; 13 is parallel to the longitudinal axis of the housing 19.

The solutions according to FIGS. 3a and 3b, FIGS. 4a and 4b and FIGS. 5a and 5b are all usable in the vibration apparatus 8, and in operation, the solutions according to FIG. 3a to FIG. 4b inclusive, will work in approximately the same way, as the vibratory forces will essentially act in a plane defined by the longitudinal and vertical direction of the vibration apparatus, whilst the solution according to FIGS. 5a and 5b will function with vibratory forces in a plane transverse to the longitudinal axis of the vibration apparatus.

FIG. 3a shows, by way of example, how the rope gripping members 9, 10 indicated in FIGS. 1 and 2 purely schematically, may be designed, and it will be seen that the respective rope gripping members 9; 10 each consist of at least three locking pins 9′, 9″, 9′″ and 10′, 10″, 10′″ which the rope 5; 6 is passed partly around in a rope-locking pattern.

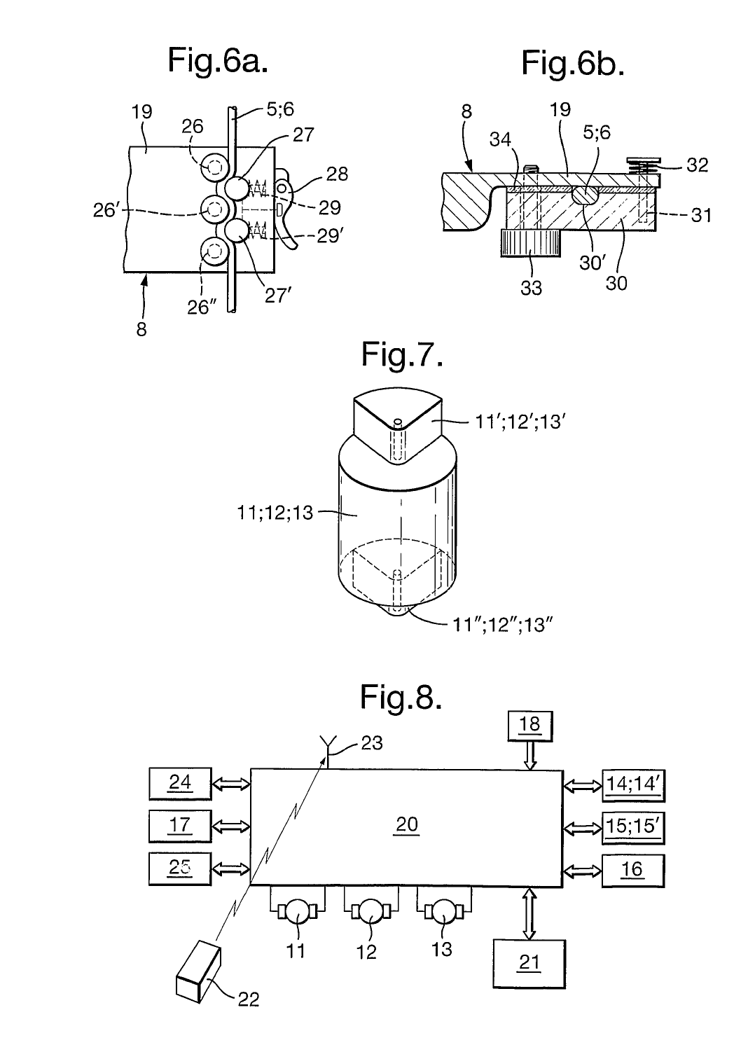

As an alternative to the solution shown in FIG. 3a (and in FIG. 4a and FIG. 5a), it is conceivable that the rope gripping members may each, for example, be configured as shown in FIG. 6a or 6b, where the rope gripping member consists of at least one spring-loaded rope gripping clamp or rope lock. FIG. 6a shows a rope gripping clamp where the rope 5; 6 can rest against, for example, three engaging pins 26, 26′, 26″ and be clamped by two spring-loaded clamping pins 27, 27′. For adjustment of the position of the vibration apparatus 8 along the ropes 5; 6, a handle 28 can be tilted slightly outwards so as to allow the clamping pins 27; 27′ to lose clamping action against the ropes. When the handle is released, the forces from springs 29, 29′ cause the clamping pins 27, 27′ to lock the rope against the engaging pins 26, 26′, 26″. FIG. 6b shows an alternative with a rope lock consisting of a gripping jaw 30 with a recess 30′ for passage of a rope 5; 6. The gripping jaw acts against a face on the vibration apparatus 8 housing 19. The gripping jaw is equipped with a hinge or a pivot pin 31 that is biased by a spring 32. The clamping effect is caused primarily by a tensioning screw 33 in cooperation with the spring 32. The gripping jaw may optionally on its face against the housing 19 be coated with an elastically resilient material 34 in order to more easily sense a gradual tightening of the screw 33 and to prevent the screw 33 from moving and losing its grip as a result of the vibrations of the vibration apparatus 8.

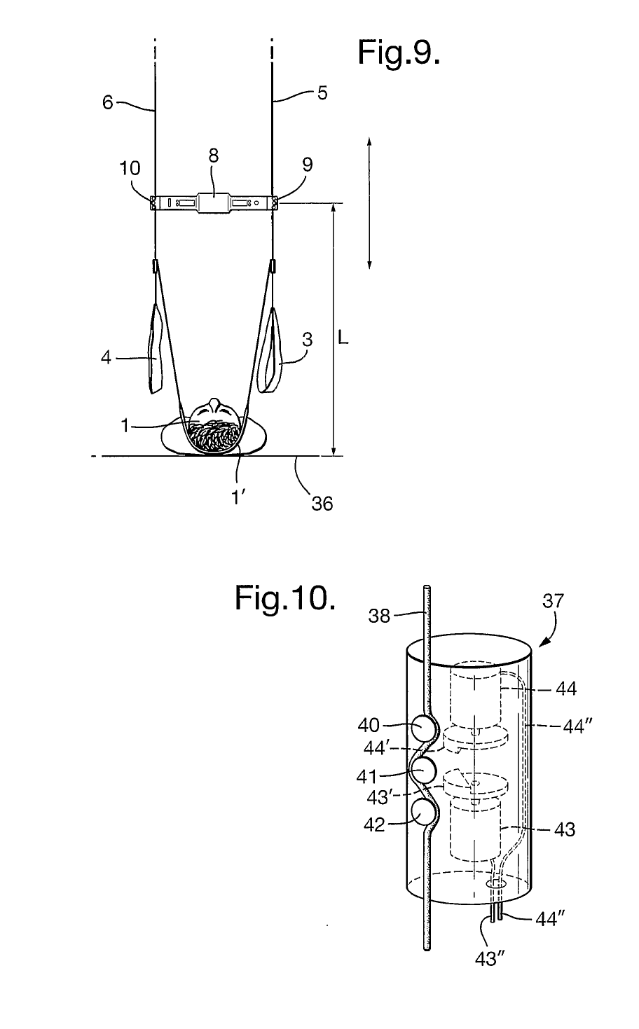

FIG. 9 shows how the user 1 lies and has his neck/head V placed in a so-called sling 35 that is attachable to the ropes 5 and 6. The vibration apparatus is, as is also shown by the arrows in FIGS. 1 and 2, level-adjustable in relation to an underlying surface 36, as for instance a floor. Such use of a sling may be appropriate when there is a need for vibratory stimulation of local joint musculature in, for example, the neck because of a defect or injury that has developed there, for example, as a result of neck strain after a rear-end collision whilst in a car, so-called whiplash injury.

The level L of the vibration apparatus 8 above the underlying surface 36 will also be determining for the vibration energy that can be transmitted to the relevant part or parts of the user's body, as for example the part V. The greater the distance L is, the smaller the amount of energy transmitted to the user will be.

FIG. 10 shows how a simplified vibration apparatus 37 would be able to cooperate with, for example, just one rope 38. Rope gripping members 39, 40 and 41 are, in the illustrated example, used to ensure that the apparatus 37 in a safe but simple way can be attached to the rope 38. In the illustrated example, two electric motors 43, 44 with associated eccentrically supported rotatable weights 43′, 44′ are used and the motors are controllable via control lines 43″, 44″ by means of external control equipment. Such a vibration apparatus would, for example, be conceivable as a supplement when using a vibration apparatus 8 as shown and described, but may also conceivably be used to cause vibration alone. The embodiment of the apparatus 8 as shown in FIGS. 1-5b and FIG. 9 is the currently preferred embodiment.

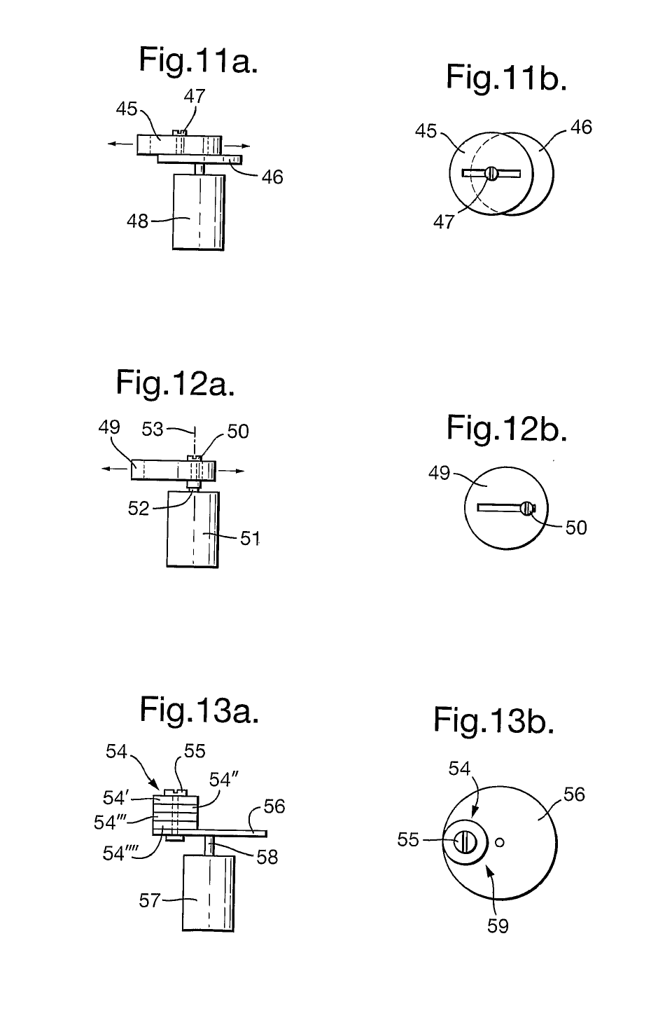

FIGS. 11a and 11b show how it would be possible to alter the vibratory force by allowing the weight 45 to be attachable by means of a screw 47 or the like to a rotating disc 46 and be radially position-adjustable on the disc 46, the disc and thus the weight being rotatable by a motor 48.

FIGS. 12a and 12b show how it would be possible to alter the vibratory force by allowing the weight 49 to be attachable by means of a screw 50 or the like to an end of the rotary shaft 52 of a motor 51, so that the centre of gravity of the weight, for example, its centre, is eccentrically positioned relative to the axis 53 of the shaft.

FIGS. 13a and 13b show how it would be possible to alter the vibratory force by allowing the weight 54 to consist of superimposed weight elements 54′, 54″, 54′″, 54″″ that are capable of being fastened together by a screw 55 or the like on a rotating disc 56 that is driven in rotation by a motor 57. The centre of gravity of the weight, for example, its centre where the screw 55 is, is eccentrically positioned relative to the rotational axis 59 of the rotary shaft 58 of the motor.

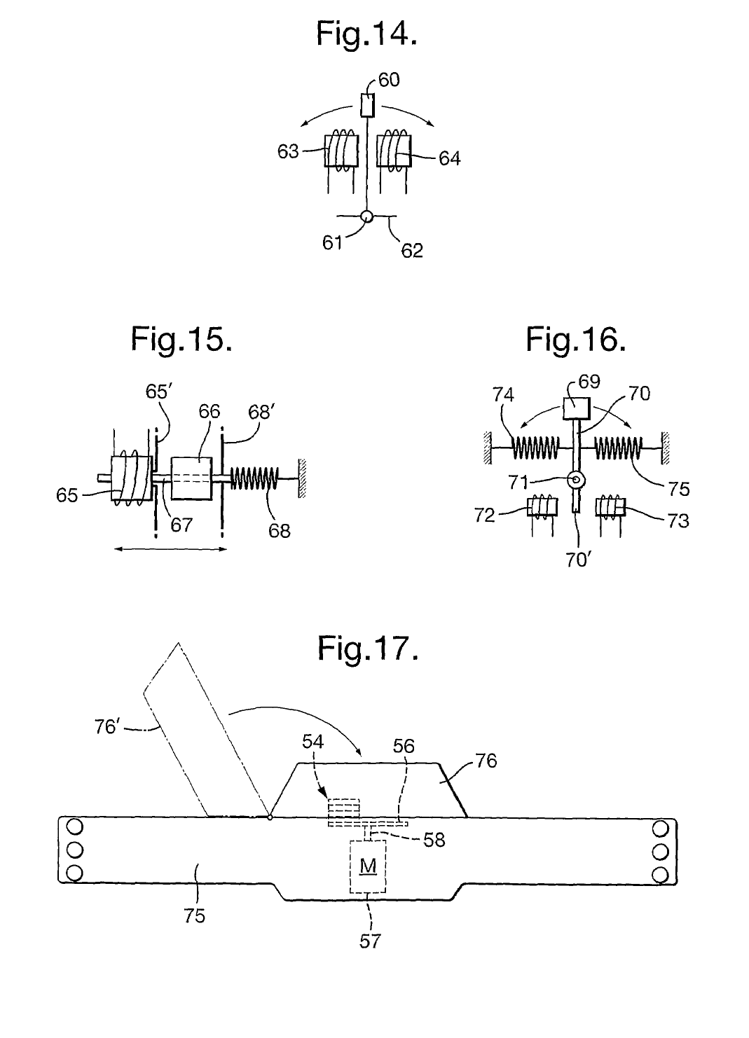

In the schematic example shown in FIG. 14, a weight 60 is hinged or journalled 61 to a base 62 and is driven back and forth by electromagnets 63, 64, which alternately cause the weight to be drawn to one side or the other, and such a solution will be simple to implement in practice. Two variants of the same principle are shown in respectively FIG. 15 and FIG. 16. FIG. 15 shows an electromagnet 65 that is stationary, a weight 66 that is movable along a shaft 67, the shaft 67 being biased by a recoil spring 68, so that when the weight, by means of the electromagnet 65, is sent in the direction of the spring 68, it will abut against a stop 68′, and thus spring back against the electromagnet 65 and a stop 65′ there. Such a vibrator is a good alternative to the solution in FIG. 14. The solution in FIG. 16 shows a weight 69 attached to a tilting arm 70 that is rotatable about a joint 71, and where the arm 70 has an end 70′ on the opposite side of the joint 71 for alternately cooperating with electromagnets 72, 73. The tilting arm 70 of the weight is expediently mounted between two springs 74, 75.

In the preferred embodiment, the intention is to utilise motors and non-adjustability of the weight of weights or the radial position of eccentrically supported weights.

If such adjustability may nonetheless be considered suitable or practical, for example, where only one motor and one weight are used, but there is a need to be able to alter the vibration energy without changing the distance L, it is possible that the vibration apparatus, here indicated by the reference numeral 75, is equipped at the top with a cover 76 that can be tilted up into a position as indicated by 76′. This allows access to the vibrator, in the illustrated example represented by the embodiment shown in FIGS. 13a, 13b, although the other embodiments as shown in, for example, FIGS. 11 and 12 are just as usable. It is of course also conceivable that the weights 60, 66 and 69 can be given a smaller or larger size, so as to thereby alter the vibration energy that is nominally delivered.

The alternatives shown in FIGS. 11-16 are merely examples, and one of skill in the art will understand that other suitable types of vibrators would also be possible.

1. A vibration apparatus for use on therapy and exercise equipment of the type that has a pair of adjustable hanging ropes to which is attached a grip portion, sling or other support member for an equipment user, the vibration apparatus being designed to extend between the ropes and controllably set the ropes in vibration, characterised in
that the vibration apparatus is freely, but fixably mountable at any level along the hanging length of the ropes by means of rope gripping members at respective ends of the apparatus; and
that the vibration apparatus has at least one electrically controllable actuator that cooperates with at least one movable weight.

2. A vibration apparatus for use on therapy or exercise equipment of the type that has one adjustable hanging rope to which is attached a grip portion, sling or other support member for an equipment user, the vibration apparatus being designed to be attachable to the rope and controllably set the rope in vibration, characterised in
that the vibration apparatus is freely, but fixably mountable at any level along the hanging length of the rope by means of rope gripping members on the apparatus; and
that the vibration apparatus has at least two electrically controllable actuators each of which cooperates with at least one movable weight.

3. A vibration apparatus as disclosed in claim 1, characterised in
that the actuator comprises an electric motor; and
that the movable weight is a relative to the rotary shaft of the motor, eccentrically supported weight.

4. A vibration apparatus as disclosed in claim 1, characterised in that said weight is differently shaped or has different weight.

5. A vibration apparatus as disclosed in claim 1, characterised in
that the vibration apparatus has a means for controlling at least one of the following parameters:
the operating frequency of the actuator(s);
duration of vibration;
selection of actuator that is to operate together with associated weight; and
selection of actuators with associated weights that are to operate simultaneously.

6. A vibration apparatus as disclosed in claim 1, characterised in
that the vibration apparatus has at least one vibration frequency in the range 10-120 Hz.

7. A vibration apparatus as disclosed in claim 1, characterised in
that at least two actuators with associated weights are arranged to operate simultaneously, so that the vibration apparatus is given a composite vibration frequency pattern with related vibratory force pattern.

8. A vibration apparatus as disclosed in claim 1, characterised in
that it is configured with an elongate rigid housing, and that said at least one actuator, configured with an electric motor and eccentrically supported weight, is positioned internally in a central area of the housing.

9. A vibration apparatus as disclosed in claim 8, characterised in
that the rotary shaft of the motor, when the apparatus is attached to the pair of ropes, has its axis parallel to the inclination of the ropes close to their connection to the apparatus.

10. A vibration apparatus as disclosed in claim 8, characterised in
that the rotary shaft of the motor, when the apparatus is attached to the pair of ropes, has its axis transverse to the housing and 90 degrees in relation to the inclination of the ropes close to their connection to the apparatus.

11. A vibration apparatus as disclosed in claim 8, characterised in
that the rotary shaft of the motor has its axis parallel to the longitudinal axis of the housing.

12. A vibration apparatus as disclosed in claim 1, characterised in
that the rope gripping members each consist of at least three locking pins which the rope is partly passed around in a rope-locking pattern.

13. A vibration apparatus as disclosed in claim 1, characterised in
that the rope gripping members each consist of at least one spring-loaded rope gripping clamp or rope lock.

14. A vibration apparatus as disclosed in claim 1, characterised in
that the actuator is configured with electric motor and eccentrically supported weight; and
that the distance of the weight from the rotary shaft of the motor is adjustable.

15. A vibration apparatus as disclosed in claim 1, characterised in
that the actuator is configured with electric motor and eccentrically supported weight; and
that the weight of the weight is adjustable.

16. A vibration apparatus as disclosed in claim 1, when subsidiary to claim 1 or 2, characterised in
that the actuator is configured with at least one electromagnet that is arranged to cause movement of a weight between respective extreme positions thereof.

17. A method for providing controllable vibration to therapy and exercise equipment of the type that has one adjustable, hanging rope or a pair of adjustable, hanging ropes to which is attached a grip portion, sling or other support member, characterised in that the vibration is selectively applicable at a desired point along the hanging length of the rope or ropes by means of at least one electrically controllable actuator.

18. A method as disclosed in claim 17, characterised in
that the vibration is determined by at least one of the following parameters:
the operating frequency of the actuator(s);
duration of vibration;
selection of actuator that is to operate together with associated movable weight; and
selection of actuators with associated movable weight that are to operate simultaneously.

19. A method as disclosed in claim 17, characterised in
that the vibration comprises at least one vibration frequency in the range 10-120 Hz.

20. A method as disclosed in claim 17, characterised in
that there is provided a composite vibration frequency pattern with related vibratory force pattern by using at least two simultaneously operating actuators with associated movable weight.

21. A method as disclosed in claim 17, characterised in
that the vibration is directed transverse to said rope or pair of ropes.

22. A method as disclosed in claim 17, characterised in
that the vibration is directed transverse to said rope or pair of ropes.

23. A method as disclosed in claim 17, characterised in
that the actuator or actuators form a part of a vibration apparatus that is attachable to the rope or pair of ropes when the rope is passed partly around at least three locking pins in a rope-locking pattern.

24. A method as disclosed in claim 17, characterised in
that the actuator or actuators form a part of a vibration apparatus that is attachable to the rope or pair of ropes in that the rope is brought into engagement with at least one spring-loaded rope gripping clamp or rope lock on the apparatus.

25. A method as disclosed in claim 17, characterised in
that as actuator there is used an electric motor and eccentrically supported weight; and
that the vibration strength/vibration energy is a function of at least one of:
the adjustable centre of gravity distance of the weight from the rotational axis of the motor;
the weight of the weight;
the progressive adjustability of the weight of the weight;
the adjustable rotational speed/rotational frequency of the weight; and
the distance of the vibration apparatus from said grip portion, sling or other support member.
